(19) United States
(12) Patent Application Publication
(10) Pub. No.: US 2025/0156626 A1
(43) Pub. Date: May 15, 2025

(54) Structured Data Objects For Dynamic Form Rendering Based On Contextual Information

(71) Applicant: Live Oak Banking Company, Wilmington, NC (US)

(72) Inventors: Gabriel Antonio Quiles-Perez, Caguas (PR); Christopher Charles Swift, JR., Apex, NC (US)

(21) Appl. No.: 18/505,779

(22) Filed: Nov. 9, 2023

(51) Int. Cl. G06F 40/166; G06F 3/0484; G06F 40/106

(52) U.S. Cl. CPC G06F 40/166; G06F 3/0484; G06F 40/106

(57) ABSTRACT

Contextual user information is obtained including information descriptive of users, and/or information provided by the users to an existing input field. Based on the contextual user information, a data object of a plurality of data objects is selected. The data object is indicative of one or more input fields of a dynamically rendered form. The data object includes information indicative of a field type for each of the one or more input fields. Rendering information is sent to a user computing device associated with a user of the users. The rendering information includes the data object and instructions to render the dynamically rendered form from the data object.

### FIELD

The present disclosure relates generally to structured data objects. More particularly, the present disclosure relates to data objects that can be utilized to render dynamically rendered forms.

### BACKGROUND

Online forms are often utilized to obtain information from users in a wide variety of use cases. Conventionally, such online forms are included as static elements within a web page constructed by engineers using a mix of markup languages, style sheets, and scripting languages. Once constructed, a web page can be rendered by a service provider and provided to a user device. In return, a user can provide contextual information to the service provider via the online form.

### SUMMARY

Aspects and advantages of embodiments of the present disclosure will be set forth in part in the following description, or can be learned from the description, or can be learned through practice of the embodiments.

One example aspect of the present disclosure is directed to a user computing device that includes one or more processor devices and one or more non-transitory computer-readable media storing instructions that, when executed by the one or more processor devices, cause the one or more processors to perform operations. The operations include sending contextual user information to a server computing system, the contextual user information comprising information descriptive of a user of the user computing device; or information received from the user via an existing input field of an existing form rendered by the user computing device. The operations include receiving, from the server computing system, a data object generated based on the contextual user information, wherein the data object is indicative of one or more input fields of a dynamically rendered form, and wherein the data object comprises information indicative of a field type for each of the one or more input fields. The operations include, based on the data object, displaying a rendering of the dynamically rendered form comprising the one or more input fields.

Another example aspect of the present disclosure is directed to a computer-implemented method for dynamic form generation based on contextual information. The method includes obtaining, by a computing system comprising one or more computing devices, contextual user information comprising one or more of information descriptive of one or more users; or information provided by the one or more users to an existing input field. The method includes, based on the contextual user information, selecting, by the computing system, a data object of a plurality of data objects, wherein the data object is indicative of one or more input fields of a dynamically rendered form, and wherein the data object comprises information indicative of a field type for each of the one or more input fields. The method includes sending, by the computing system, rendering information to a user computing device associated with a user of the one or more users, wherein the rendering information comprises the data object and instructions to render the dynamically rendered form from the data object.

Another example aspect of the present disclosure is directed to one or more non-transitory computer-readable media storing instructions that, when executed by one or more processor devices, cause the one or more processor devices to perform operations. The operations include obtaining contextual user information comprising one or more of information descriptive of one or more users, or information provided by the one or more users to an existing input field. The operations include, based on the contextual user information, selecting one or more input fields for inclusion in a data object. The operations include generating the data object, wherein the data object is configured to cause a recipient device to render a dynamically rendered form from the data object, and wherein the data object comprises information indicative of a field type for each of the one or more input fields. The operations include sending rendering information to a user computing device associated with a user of the one or more users, wherein the rendering information comprises the data object and instructions to render the dynamically rendered form from the data object.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment suitable for modifying or generating data objects for dynamic form generation according to some implementations of the present disclosure.

FIG. 2 is a data flow diagram for client-side dynamic rendering of a form based on a structured data object according to some implementations of the present disclosure.

FIG. 3A depicts a flow chart diagram of an example method to perform local dynamic rendering of a dynamically rendered form from a data object according to example implementations of the present disclosure.

FIG. 3B depicts a flow chart diagram of an example method to perform modification or generation of a data object for local dynamic rendering of a dynamically rendered form according to example implementations of the present disclosure.

FIG. 4 depicts a block diagram of an example computing system that provides data objects for rendering of dynamically rendered forms according to example implementations of the present disclosure.

### DETAILED DESCRIPTION

The present disclosure relates generally to structured data objects. More particularly, the present disclosure relates to data objects that can be utilized to render dynamically rendered forms. As described previously, forms are often utilized to obtain information from users in a wide variety of use cases. Such forms are constructed by engineers using a mix of languages and are provided to users. Information entered to these forms by users can be received by the service provider.

Modifying existing forms, and/or creating new forms, can be prohibitively difficult. For example, service providers that provide technically complex services (e.g., financial transactions, medical records, etc.) may maintain thousands of forms (or more) created to obtain various types of information from users. However, changes made to products or services offered by such service providers can necessitate corresponding changes to some (or all) of the forms being maintained by the service provider, which can be prohibitively expensive. Additionally, these forms generally cannot be dynamically modified using conventional approaches. As such, service providers are forced to make certain input fields required even if the fields are only applicable to a small subset of users, thus forcing most users to enter redundant information.

Accordingly, implementations of the present disclosure propose data objects that can be utilized to render dynamically rendered forms. More specifically, assume that a computing system for a service provider implements forms to obtain information from users. The computing system can receive contextual information from a user computing device. The contextual information can include information that describes certain characteristics of the user of the user computing device (e.g., name, address information, user account information, preferences, prior authorizations, etc.). Additionally, or alternatively, the contextual user information can include information received from the user via an input field of an existing form being rendered by the user computing device (e.g., a prior form in a series of forms).

Based on the contextual information, the computing system can generate or modify a data object. The data object can include, or otherwise indicate, one or more input fields for inclusion in a dynamically rendered form. More specifically, the data object can be configured such that a form can be dynamically rendered from the data object. For example, the data object can be a structured data object (e.g., a Javascript Object Notation (JSON) object) that is indicative of a dynamically rendered form. The data object can indicate whether certain fields should be included in a form, a location of the fields within the form, pre-populated content for the fields, etc. By generating or modifying a dynamically rendered form, the computing system can eliminate the collection of redundant information by tailoring forms to specific users.

For example, assume that the contextual user information includes information from the user indicating that the user's state of residence is North Carolina. Further assume that North Carolina has certain regulations specific to the industry of the service provider that most other states do not, and that such regulations necessitate additional information from the user. Based on the contextual information, the computing system can modify an existing data object to add an input field for obtaining the additional information from the user. The computing system can then provide the data object so that the dynamically rendered form can be rendered and displayed at the user computing device. In such fashion, the computing system can modify and/or generate data objects from which forms can be dynamically rendered.

It should be noted that implementations described herein discuss the collection and utilization of various types of data. Any mention of data associated with users, as described herein, can be securely stored and protected against any type of unauthorized use or access. In addition, sensitive information, such as user data, is collected only with the express permission of said users. Users are provided the option to opt-out, or otherwise opt-in, to collection of such data.

Aspects of the present disclosure provide a number of technical effects and benefits. As one example technical effect and benefit, implementations of the present disclosure can substantially reduce the time required for users to complete online forms, thus increasing user satisfaction and substantially reducing compute resources necessary to collect such information from users. For example, using conventional techniques, most online forms must necessarily collect redundant information from users to provide coverage for niche scenarios (e.g., regulatory information for a particular state, etc.). However, by rendering forms from a generated/modified data object, implementations of the present disclosure can efficiently tailor forms to users, eliminating the need to acquire redundant information and thus substantially reducing compute resources utilized to provide forms to users (e.g., power, memory, storage, compute cycles, etc.).

As another example technical effect and benefit, implementations of the present disclosure can substantially reduce utilization of compute resources for providing forms to users. Specifically, a conventional online form is rendered and then stored to a computing system of a service provider. The rendered form can be transmitted to a user computing device so that the user can input information to the form. However, implementations of the present disclosure can be utilized to create a data object from which a form can be dynamically rendered by a user computing device. By only storing and transmitting a data object, rather than a rendered online form, implementations of the present disclosure can substantially reduce bandwidth utilization and storage resource utilization.

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

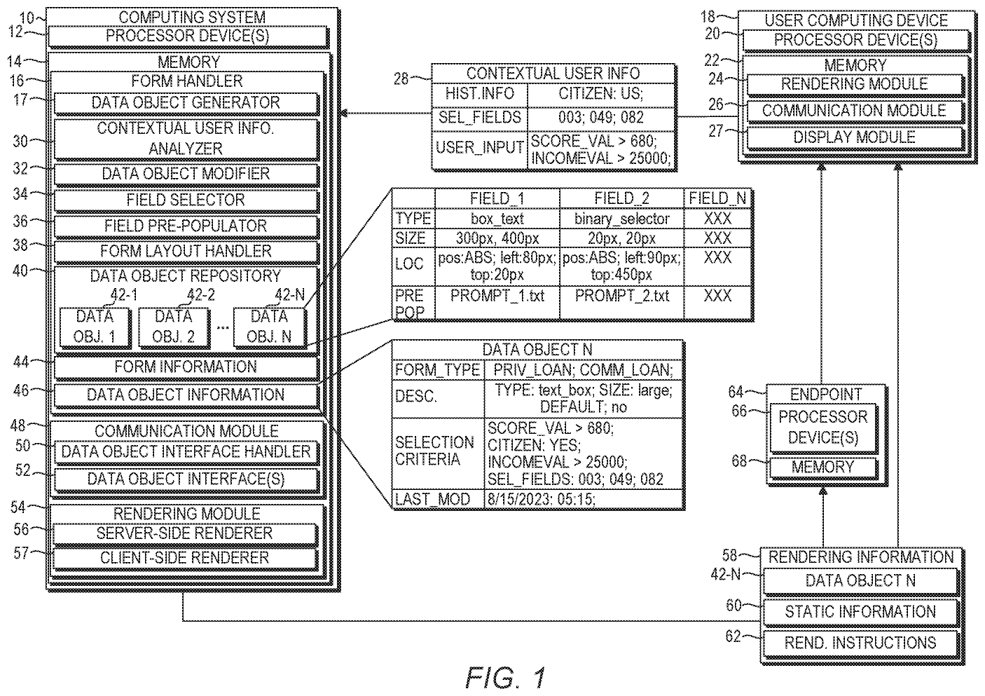

FIG. 1 is a block diagram of an environment suitable for modifying or generating data objects for dynamic form generation according to some implementations of the present disclosure. A computing system 10 includes processor device(s) 12 and memory 14. In some implementations, the computing system 10 may be a computing system that includes multiple computing devices. Alternatively, in some implementations, the computing system 10 may be one or more computing devices within a computing system that includes multiple computing devices. Similarly, the processor device(s) 12 may include any computing or electronic device capable of executing software instructions to implement the functionality described herein.

The memory 14 can be or otherwise include any device(s) capable of storing data, including, but not limited to, volatile memory (random access memory, etc.), non-volatile memory, storage device(s) (e.g., hard drive(s), solid state drive(s), etc.). In particular, the memory 14 can, in some implementations, include a containerized unit of software instructions (e.g., a “packaged container”). A containerized unit of software instructions can collectively form a container that has been packaged using any type or manner of containerization technique.

The memory 14 can include a form handler 16. The form handler 16 can be a system (e.g., hardware, software, containerized software, compute resources, etc.) that implements, orchestrates, and/or provides forms to obtain information from users of a service provider associated with the computing system 10 (e.g., a financial service provider, a computing service provider, a commercial service provider, etc.). In particular, the form handler 16 can manage a number of forms that are provided in a specific sequence to collect contextual information from users so that certain services can be provided.

As an example, assume that the computing system 10 is a computing system for a service provider that provides relatively sophisticated services (e.g., financial services such as loan syndication) and thus requires detailed contextual information from a user. The form handler 16 can generate a data object with a data object generator 17. The data object generator 17 can generate data objects configured such that a form can be dynamically rendered from the data object. The form handler 16 can generate a data object with the data object generator 17 from which a first form in a series of forms can be rendered (not illustrated). The computing system 10 can provide the data object to a user computing device 18 associated with the user.

The user computing device 18 can include processor device(s) 20 and a memory 22 as described with regards to the processor device(s) 12 and the memory 14 of the computing system 10. The memory 22 of the user computing device 18 can include a rendering module 24, a communication module 26, and a display module 27. The rendering module 24 can handle either client side rendering, server side rendering, or a mix of both. Client and server side rendering will be discussed in greater detail further into the specification. The communication module 26 can transmit and receive information from other devices, such as the computing system 10. The display module 27 can display various programs and applications, such as a web browser application or some other application that can access dynamically rendered forms.

The user computing device 18 can render the first form with the rendering module 24. The user of the user computing device 18 can provide information to input fields of the first form. The user computing device 18 can send contextual user information 28 to the computing system 10. The contextual user information can include information descriptive of the user of the user computing device.

In some implementations, the information descriptive of the user included in the contextual user information 28 can include user preferences. For example, prior to sending the contextual user information 28, the user can provide an input indicating that the user does not generally wish to receive physical mail communications. The contextual user information 28 can include information indicating this preference. In this manner, if a subsequent form included an input field for indicating whether users wish to receive physical mail communications, the computing system can remove that input field based on the contextual information.

Additionally, or alternatively, in some implementations, the information descriptive of the user included in the contextual user information 28 can include historical user information. The historical user information can include information previously provided by the user to input fields of other forms, such as residence, address, name, identifying information (e.g., drivers license number, social security number, etc.), emergency contact information, etc. To follow the illustrated example, the historical user information of the contextual user information 28 can indicate that the user of the user computing device 18 is a citizen of the United States.

Additionally, or alternatively, in some implementations, the contextual user information 28 can include information descriptive of the user computing device 18. The information descriptive of the user computing device 18 can indicate various performance characteristics of the user computing device 18, peripheral devices accessible to the user computing device 18 (e.g., input devices, output devices, etc.), sensor devices accessible to the user computing device 18 (e.g., microphones, cameras, etc.), network availability for the user computing device 18, etc.

For example, the contextual user information 28 can indicate that the user computing device 18 does not have access to a textual input device, such as a keyboard. In response, the form handler 16 can modify subsequent data objects to utilize computer vision as a default form of information capture for fields with a textual capture input type (e.g., for entering a driver's license number, etc.), or may modify a data object to remove certain fields with a textual capture input type. For another example, the contextual user information 28 can indicate that the user computing device 18 does not have access to an audio output device. In response, the form handler 16 can modify a data object to remove interface elements that perform text-to-speech operations for prompts included in the form. For yet another example, the contextual user information 28 can indicate that the user computing device 18 does have access to a high-bandwidth wireless network. In response, the form handler 16 can modify a data object to include image prompts that depict a correct way to input information to the form.

In some implementations, the contextual user information 28 can include information received from the user via an existing input field of an existing form rendered by the user computing device 18. For example, as described previously, the user computing device 18 can receive a data object from the computing system 10 generated with the data object generator 17. The user computing device 18 can render a form from the data object with the rendering module 24. The user can input information to the forms, and the input information can be included in the contextual user information 28. To follow the depicted example, the user can provide input information indicating that the user has a credit score greater than 680 and an income greater than 25,000.

The form handler 16 can receive the contextual user information 28. Based on the contextual user information 28, the form handler 16 can either generate a data object or modify an existing data object. To do so, the form handler 16 can include a contextual user information analyzer 30. The contextual user information analyzer 30 can analyze the contextual user information 28 to determine whether to generate a data object and/or whether to modify an existing data object. If the contextual user information analyzer 30 determines to generate a data object, the form handler 16 can utilize the data object generator 17 to do so. If the contextual user information analyzer 30 determines to modify an existing data object, the form handler 16 can utilize a data object modifier 32 to do so.

The form handler 16 can include a field selector 34. The field selector 34 can be utilized by either the data object generator 17 or the data object modifier 32 to select fields for inclusion in a dynamically rendered form. More specifically, the field selector 34 can select fields to be indicated by a data object that represents a dynamically rendered form. For example, assume that the contextual user information 28 indicates that the user is not a citizen of the United States. Based on the contextual user information 28, the field selector 34 can select a field for a form that obtains citizenship information from the user (e.g., a drop-down form that allows the user to select their country of citizenship.).

The field selector 34 can select a field type for each field included in a data object. A field type can be any type or manner of field that can be included in a form, such as selectable interface elements (e.g., radio buttons, drop-down menus, etc.), textual input fields, audio input fields, image input fields, payment fields (e.g., credit card input fields that automatically recognize certain types of credit cards, etc.), etc. The field selector 34 can also select certain parameters for input fields. For example, a field selector 34 can select a field with a textual input field type for inclusion in a data object. The field selector 34 can also select a value of 500 characters for a maximum character parameter for the field.

For another example, assume that the next data object to be provided to the user computing device 18 is a radio button field that only permits a single element to be selected. Based on the contextual user information 28, the field selector 34 determines that multiple elements are relevant to the user. In response, the field selector 34 can modify the field type of the radio button field to be a checkbox field type that allows the user to select multiple elements.

The form handler 16 can include a field pre-populator 36. The field pre-populator 36 can pre-populate fields with prompts and/or other information. For example, assume that the contextual user information 28 indicates a recent change in a user's employment. The field selector 34 can select a field with a textual input field type (e.g., a text box that a user can input text to). The field pre-populator 36 can pre-populate the field with text that prompts the user to provide an explanation for the change in the user's employment. In this manner, the form handler 16 can dynamically handle contingencies or unexpected information included in the contextual user information 28.

Additionally, in some implementations, the field pre-populator 36 can generate or select prompt information for particular fields. To follow the previous example, the field selector 34 can select the field with the textual input field type. Rather than populating the field itself with the prompt to the user, the field pre-populator 36 can place the prompt adjacent to the field (e.g., above the field, to the side of the field, etc.).

In some implementations, the contextual user information analyzer 30, field selector 34, and/or the field pre-populator 36 can leverage various machine learning techniques to analyze the contextual user information 28 and/or perform various other functions. More specifically, in some implementations, the contextual user information analyzer 30 can include, or otherwise access, a machine-learned model that can process structured or unstructured information to provide a discriminative or generative output.

In some implementations, the contextual user information analyzer 30 can access a model (e.g., a Large Language Model (LLM)) that is trained to process contextual user information to generate a model output. In some implementations, the model output can indicate whether to generate a data object or to modify an existing data object. Additionally, or alternatively, in some implementations, the model output can identify whether information provided by the user necessitates the collection of additional information from the user.

For example, assume that the user previously indicated that they have been employed by three different entities within the past year. The contextual user information 28 can include textual content input by the user to explain the changes in employment. The textual content can include an explanation for ceasing employment for the first and second entities, but can lack an explanation for ceasing employment with the third entity. The contextual user information analyzer 30 can process the contextual user information 28 with the machine-learned model to obtain a model output. The model output can indicate that a field should be included in the next data object provided to the user computing device 18 so that the user can provide an explanation for ceasing employment with the third entity.

To continue the previous example, the contextual user information analyzer 30 can determine that the next data object to be provided to the user computing device 18 can be modified to include the field. The field selector 34 can select a field with a textual input field type to be added to the data object. The field pre-populator 36 can pre-populate the field or a space adjacent to the field with textual content that prompts the user to provide an explanation for ceasing employment with the third entity. For example, the model output from the contextual user information analyzer 30 can be a language output that includes the textual content utilized by the field pre-populator 36 (e.g., “Please provide an explanation for leaving your third job”). In this manner, the form handler 16 can solicit additional information based on a contextual understanding of a free-form response provided by the user.

The form handler 16 can include a form layout handler 38. The form layout handler 38 can select a layout for a field to be indicated by a data object. More specifically, the form layout handler 38 can determine a position for selected fields within the form when the form is rendered from the data object. For example, the field selector 34 can select a field with a radio button field type. The form layout handler 38 can determine a location for the field within the form when the form is dynamically rendered from the data object.

The form handler 16 can include a data object repository 40. The data object repository 40 can include data objects 42-1-42-N (generally, data objects 42). The data objects 42 can be data objects previously generated with the data object generator 17. Each of the data objects 42 can be configured such that a form can be dynamically rendered based on the data object. For example, the data object 42-1 can be a data object for a first form in a sequential series of forms provided to a user in response to a request for a particular service from the service provider. The data object 42-2 can be a data object for the second form in the sequential series of forms provided to the user.

As described previously, each of the data objects 42 can be configured such that a dynamic form can be rendered from the data object. To do so, the data objects 42 can be configured for ingestion by a server-side renderer or a client-side renderer, such as the rendering module 24 of the user computing device 18. Specifically, the data objects 42 can be structured data objects that are structured to indicate the content and layout of a rendered form. The rendering module 24 can process a data object and render a form based on the information included in the data object 42.

To follow the depicted example, the data object 42-N can be a structured data object (e.g., a JSON data object) that includes information descriptive of a particular field to be included in a dynamically rendered form. In particular, the data object 42-N can specify that the field is to have a textual input field type (e.g., a text box), a size of 300 pixels by 400 pixels, a relative location for the field within the dynamically rendered form, and pre-populated textual content to be placed in the field or adjacent to the field.

The form handler 16 can include form information 44. The form information 44 can store information descriptive of the data objects 42. In particular, the form information 44 can store information that groups data objects that correspond to forms in a series of forms. To follow the previous example, the form information 44 can indicate that the data object 42-1 represents the first form in a particular series of forms, and that the data object 42-2 represents the second form in the particular series of forms. In some implementations, the form information 44 can be stored in a database or data store, such as relational database, that can store relations between data objects 42.

The form handler 16 can include data object information 46. The data object information 46 can include information descriptive of each of the data objects 42. In particular, the data object information 46 can include information that describes other characteristics of a data object, such as the type of form corresponding to the data object, each field included in the data object, selection criteria for the data object, metadata for the data object, etc. To follow the depicted example, the data object information 46 can indicate that data object 42-N is configured for rendering a form for either private loans or commercial loans. The data object information 46 can indicate that one of the input fields included in the form corresponding to data object 42-N is a large text box that is not a default field. The data object information 46 can indicate certain selection criteria that must be fulfilled before providing the data object to the computing device 18 (e.g., a credit score, citizenship, income amount, previously selected fields, etc.).

In particular, the selection criteria of the data object information 46 can indicate certain fields required to have been previously selected by the user. To follow the depicted example, the contextual user information 28 indicates that the user has selected fields 003, 049, and 082. Assume that fields 003, 049, and 082 are fields that can be selected by the user, such as binary selector field types (e.g., a field to indicate a binary yes/no answer to a prompt). The selection criteria of the data object information 46 for the data object 42-N can require the user of the user computing device 18 to have previously selected fields 003, 049, and 082 for the data object 42-N to be selected (e.g., by the field selector 34.).

For a specific example, assume that the field with field identifier 003 prompts the user to indicate whether they are a United States citizen, the field with field identifier 049 prompts the user to indicate whether they are a resident of the United States. Further assume that the field with field identifier 082 is an optional field that is rendered if the user answers “no” to fields 003 and 082, and that the prompts the user to indicate their citizenship. In this instance, the data object 42-N can be configured for rendering a form that is specific to the citizenship indicated by the user to the field with the field identifier 082 (e.g., if the user's citizenship is Chinese, the data object 42-N can be configured such that pre-populated field content can be displayed in Mandarin).

The form handler 16 can include a communication module 48. The communication module 48 can manage active connections between the form handler 16 and various computing entities, such as the user computing device 18. Specifically, the connection module 48 can, in some implementations, implement sockets for exchanging information with the computing entities. The sockets can be utilized to facilitate active connections between the from handler 16 and the computing entities. The sockets can be implemented using any type or manner of networking protocols or technologies. For example, the sockets can be Transmission Control Protocol (TCP) sockets that include an Internet Protocol (IP) address and a corresponding port.

The communication module 48 can include a data object interface handler 50. The data object interface handler 50 can generate, modify, or otherwise manage data object interface(s) 52 between rendered forms and the form handler 16. More specifically, the data object interface handler 50 can handle various data object interface(s) 52 to ingest contextual user information 28 provided by computing devices such as the user computing device 18. For example, the data object interface handler 50 can implement an Application Programming Interface (API) configured to parse the contextual user information 28 into constituent data elements (e.g., historical information, selected fields, user input information, etc.).

The data object interface handler 50 can create new data object interface(s) 52, or modify existing data object interface(s) 52, in response to actions performed by the data object generator 17 and the data object modifier 32, respectively. For example, assume that the data object modifier 32 modifies the data object 42-N to include a binary selector input field with a field identifier of 099. The data object interface handler 50 can modify one of the data object interfaces 52 that corresponds to the data object 42-N such that the data object interface 52 can properly parse the output from the binary selection field.

The computing system 10 can include a rendering module 54. The rendering module 54 can dynamically render forms from the data objects 42. The rendering module 54 can render such forms from the data objects 42 using a client-side rendering process, a server-side rendering process, or a mix of both client-side and server side rendering processes. To do so, the rendering module can include a server-side renderer 56 and a client-side renderer 57.

The server-side renderer 56 can perform a server-side (or partial server-side) rendering process. To do so, the server-side renderer 56 can generate rendering information 58. The rendering information 58 can include a data object, such as the data object 42-N. The rendering information 58 can include static information 60. The static information 60 can be programmatic instructions, ingestible instructions, etc. for rendering static portions of the form (e.g., a background color or texture, a skeleton layout of the form, various images, logos, interface elements, etc.). Additionally, in some implementations, the rendering information 58 can include rendering instructions 62. The rendering instructions 62 can include different instructions based on whether the rendering instructions 62 is generated by the server-side renderer 56 or the client-side renderer 57.

Based on the rendering information 58, the server-side renderer 56 can dynamically render a form from the data object 42-N and host the dynamically rendered form on a web page accessible to the user computing device 18. Alternatively, in some implementations, the server-side renderer 56 can instruct a network endpoint 64 within a computing network that includes the computing system 10 to render and host the dynamically rendered form. For example, assume that the computing system 10 is one of multiple computing entities of a computing network associated with a large service provider. This computing network can include the network endpoint 64.

The network endpoint 64 can be a physical and/or virtualized collection of hardware and/or software resources utilized to host information that is accessible to computing devices such as the user computing device 18. In particular, the network endpoint 64 can include processor device(s) 66 and a memory 68 as described with regards to the processor device(s) 12 and the memory 14 of the computing system 10. For example, the network endpoint 64 may be an endpoint node in a Content Distribution Network (CDN).

In some implementations, the server-side renderer 56 can provide the rendering information 58 to the network endpoint 64. The rendering information 58 can instruct the network endpoint 64 to dynamically render a form from the data object 42-N. In some implementations, the rendering instructions 62 can be programmatic instructions that cause the network endpoint 64 to dynamically render the form from the data object 42-N. For example, the data object 42-N can be a type of structured data object with a particular corresponding module that is configured to render data objects of that particular type. This module can be any type or manner of programmatic instructions, such as a library, a script, an executable, a cloud service, a network service, a set of programmatic instructions, etc.

The rendering instructions 62 can instruct the endpoint 64 to utilize that particular module to dynamically render the form from the data object 42-N. If the endpoint 64 does not have access to the module, the rendering instructions 62 can include additional instructions that instruct the endpoint to access the module (e.g., instantiate the module, download and install the module, utilize an intermediary network service or endpoint to access the module, etc.).

The network endpoint 64 can dynamically render the form from the data object 42-N based on the rendering instructions 62. The network endpoint 64 can then host a web page that includes the dynamically rendered form. The network endpoint 64 can communicate with the user computing device 18 so that the user computing device 18 accesses the web page that hosts the dynamically rendered form.

In some implementations, the network endpoint 64 can receive the contextual user information 28 and forward the contextual user information 28 to the computing system. For example, the network endpoint 64 may collect contextual user information 28 from the user computing device 18 and from other computing devices. The network endpoint 64 can parse sets of received contextual user information and provide the parsed information to the computing system 10.

Alternatively, in some implementations, the client-side renderer 57 can be utilized to perform a client-side rendering process. As described herein, a client-side rendering process generally refers to a process in which a data object is provided to a computing device and the computing device locally and dynamically renders a form from the data object. To do so, the client-side renderer 57 can generate the rendering information 58. The rendering information 58, when generated by the client-side renderer 57, can include the data object 42-N to be rendered locally, the static information 60, and the rendering instructions 62. In some implementations, the static information 60 can include “placeholder” programmatic instructions (e.g., instructions in a markup language such as HTML, style information such as Cascading Style Sheets (CSS), etc.) that can be utilized to render a placeholder page while the data object 42-N is locally rendered by the user computing device 18.

Additionally, the rendering information 58 can include the rendering instructions 62. When generated by the client-side renderer 57, the rendering instructions 62 can instruct the user computing device 18 to dynamically render the form from the data object 42-N. For example, similarly to the rendering instructions 62 provided to the network endpoint 64, the rendering instructions 62 can instruct the user computing device 18 to utilize a particular module to render the data object 42-N, and if the user computing device 18 cannot access the module, the rendering instructions 62 can cause the user computing device 18 to obtain access to the module.

In some implementations, the form handler 16, or other modules of the form handler 16, can modify and/or generate the rendering information 58. For example, the data object interface handler 50 can modify or generate a portion of the rendering information 58 to define an endpoint to which the user computing device 18 can transmit the contextual user information 28.

In response to receiving the rendering information 58 from the client-side renderer 57, the user computing device 18 can dynamically render the form from the data object 42-N with the rendering module 24. While rendering the form, the user computing device 18 can render a static page, or “placeholder’ page, from the static information 60. In this manner, the user computing device 18 can reduce the perceptible latency associated with dynamically rendering the form from the data object 42-N. The user computing device 18 can display the dynamically rendered form via a display device using the display module 27. For example, the display module 27 can cause a web browser being used to access the dynamically rendered form to be displayed in a display device.

In such fashion, the computing system 10 can modify, or generate, the data object 42-N and cause a form to be dynamically rendered from the data object 42-N. By managing the data objects 42, rather than discrete static forms, the computing system 10 can substantially reduce utilization of the processor device(s) 121, the memory 14, the network endpoint 64, and bandwidth utilized to communicate with the user computing device 18.

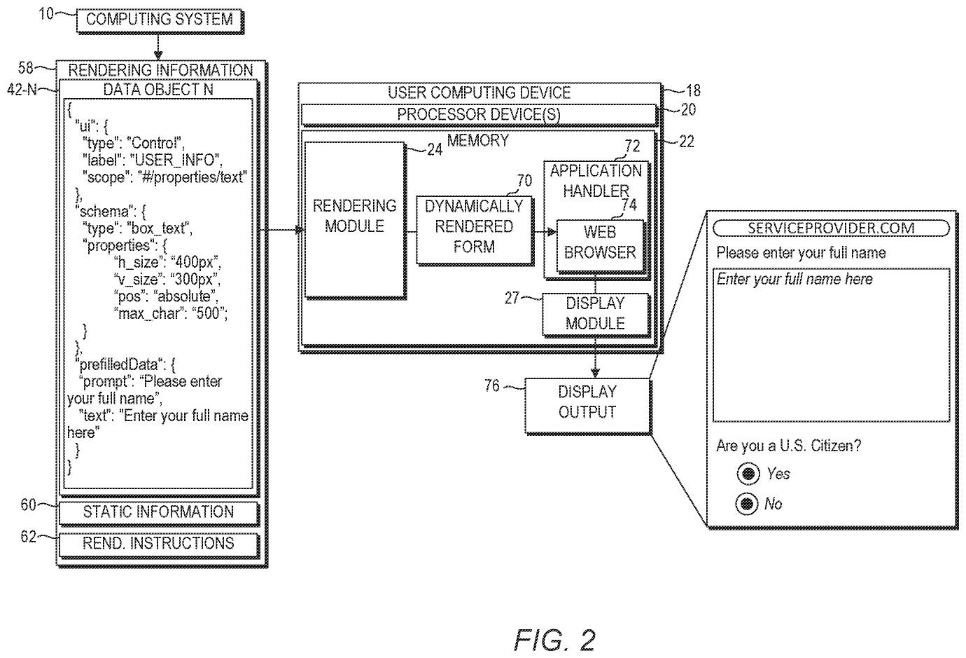

FIG. 2 is a data flow diagram for client-side dynamic rendering of a form based on a structured data object according to some implementations of the present disclosure. FIG. 2 will be discussed in conjunction with FIG. 1. Specifically, the computing system 10 can generate the rendering information 58. The rendering information 58 can include the data object 42-N, the static information 60, and the rendering instructions 62. In particular, as depicted, the data object 42-N can be a JSON data object that defines a “USER_INFO” field with a textual input box field type. The data object 42-N can additionally define a shape and position for the textual input box field (e.g., a horizontal size of 400 pixels, a vertical size of 300 pixels, etc.) and other characteristics or parameters of the field (e.g., a max character limit of 500 characters). Further, the data object 42-N can define textual content to pre-populate the field itself (e.g., “enter your full name here”), and a prompt to be placed adjacent to the field (e.g., “Please enter your full name”).

The user computing device 18 can receive the rendering information 58 from the computing system 10. The user computing device 18 can process the rendering information 58 with the rendering module 24 to obtain a dynamically rendered form 70. In other words, the rendering module 24 can render the dynamically rendered form 70 based on the rendering information 58.

Specifically, the rendering module 24 can first parse the data object 42-N to identify fields to be included in the dynamically rendered form 70, field types for those fields, a layout for the fields, etc. For example, the rendering module 24 can include, or otherwise have access to, a library or other grouping of programmatic instructions that is configured to parse the data object 42-N to extract such information. Once parsed, the rendering module 24 can render the dynamically rendered form 70 as specified by the data object 42-N.

In some implementations, the rendering module 24 may first render static elements of the dynamically rendered form based on the static information 60. For example, if the static information 60 defines interface elements, a navigation bar, logos, a background color, etc., the rendering module 24 can render those elements of the form while parsing and rendering the rendering module 24. In this manner, any delay associated with parsing and rendering time for the dynamically rendered form 70 can be perceptibly reduced, as the rendering of the static elements is visible and thus can serve as confirmation that the rendering module 24 is working to dynamically render the dynamically rendered form 70.

The user computing device 18 can display the dynamically rendered form. Specifically, the dynamically rendered form 70 can be displayed within a suitable application configured to display such forms. An application can be selected to load the dynamically rendered form 70 by an application handler 72 of the user computing device 18. The application handler 72 can select a web browser application 74 to load the dynamically rendered form 70. Once loaded, the user computing device 18 can utilize a display module 27 to display a view of the web browser 74, thus displaying a view of the dynamically rendered form 70. In particular, the display module 27 can generate a display output 76 that depicts the view of the web browser 74 that has loaded the dynamically rendered form 70. The display output 76 can be any type or manner of encoded image information that can be output at a monitor or other display device.

The display output 76 can encode a view of the web browser 74 that has loaded the dynamically rendered form 70. The dynamically rendered form 70 can include the form defined by the data object 42-N. Specifically, to follow the depicted example, the data object 42-N can define a field with a field type of “box_text”, a horizontal size of “400px”, a vertical size of “300px”, a character limit of “500”, etc. Additionally, the data object 42-N can include textual content to “pre-fill” the field and additional textual content to serve as a prompt adjacent to the field. In response, the dynamically rendered form 70 can include a text box field with a size of 300px×400px, pre-filled textual content (e.g., enter your full name here”), an adjacent prompt (e.g., “Please enter your name”), etc.

Although not depicted, the data object 42-N can define additional fields other than the depicted text box field, such as radio buttons, checkbox buttons, a slider elements, drop-down menus, etc. To follow the depicted example, the data object 42-N can further define an additional field with a binary radio button field type. The data object 42-N can define a prompt to be located adjacent to the binary radio button field. In this manner, the data object 42-N can select multiple fields for inclusion, and can further define the locations of those fields within the dynamically rendered form 70.

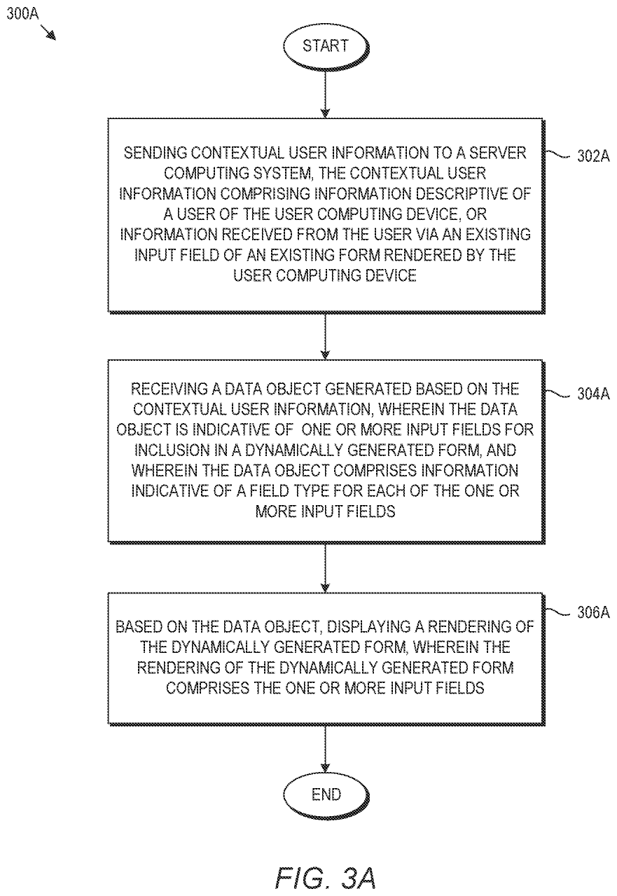

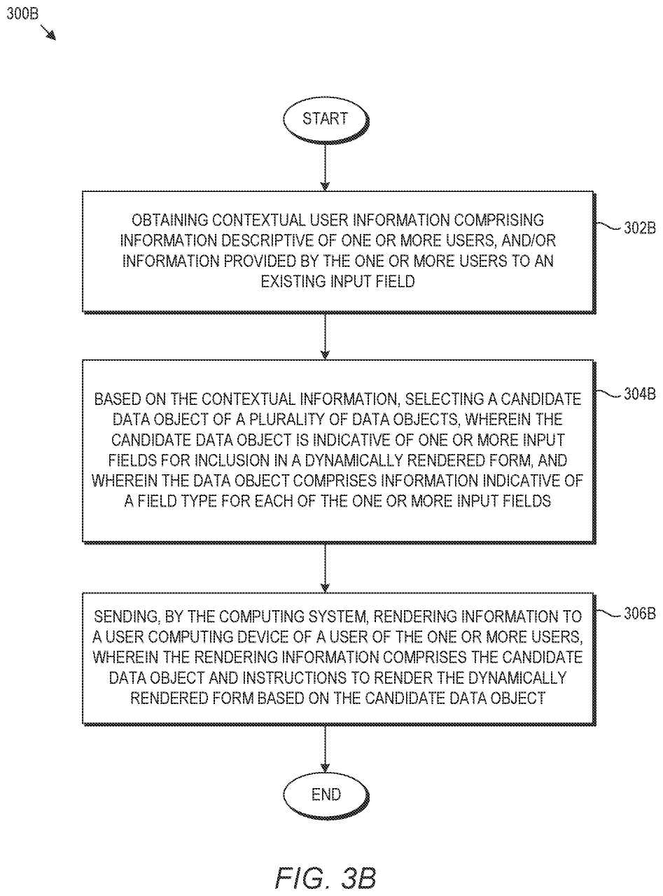

FIG. 3A depicts a flow chart diagram of an example method 300A to perform local dynamic rendering of a dynamically rendered form from a data object according to example implementations of the present disclosure. Although FIG. 3A depicts operations performed in a particular order for purposes of illustration and discussion, the methods of the present disclosure are not limited to the particularly illustrated order or arrangement. The various operations of the method 300A can be omitted, rearranged, combined, and/or adapted in various ways without deviating from the scope of the present disclosure.

At operation 302A, a computing device (e.g., a user computing device) can send contextual user information to a server computing system. The contextual user information can include information descriptive of a user of the user computing device. Additionally, or alternatively, the contextual user information can include information received from the user via an existing input field of an existing form rendered by the user computing device.

In some implementations, the data object can further include information indicative of a layout of the one or more input fields within the dynamically rendered form.

In some implementations, sending the contextual user information to the server computing system includes sending the information received from the user via the existing input field of the existing form rendered by the user computing device. To display the rendering of the dynamically rendered form, the computing device can receive an input from the user. The input can select a navigation interface element that navigates from the existing form rendered by the user computing device to a subsequent form. The user computing device can obtain the rendering of the dynamically rendered form, and based on the data object, display the rendering of the dynamically rendered form.

In some implementations, obtaining the rendering of the dynamically rendered form can include generating the rendering of the dynamically rendered form based on the data object. Alternatively, in some implementations, obtaining the rendering of the dynamically rendered form can include receiving the rendering of the dynamically rendered form from a computing entity other than the user computing device (e.g., the server computing system, a network endpoint associated with the server computing system, etc.).

At operation 304A, the computing device can receive a data object generated based on the contextual user information from the server computing system. The data object can be indicative of one or more input fields of a dynamically rendered form. The data object can include information indicative of a field type for each of the one or more input fields.

At operation 306A, the computing device can, based on the data object, display a rendering of the dynamically rendered form that includes the one or more input fields.

In some implementations, the computing device can receive user input information input by the user to the one or more input fields. In some implementations, the data object can further include interface information that defines a particular data object format that is compatible with a dynamic form interface of the server computing system. The computing device can generate a response data object of the particular data object format based on the interface information. The response data object can be descriptive of the user input information. The computing device can send the response data object to the server computing system via the dynamic form interface of the server computing system.

In some implementations, the computing device can receive instructions to apply one or more modifications to the dynamically rendered form. The instructions can be based at least in part on the user input information. The computing device can apply the one or more modifications to the rendering of the dynamically rendered form. In some implementations, to apply the one or more modifications to the rendering of the dynamically rendered form, the computing device can modify the rendering of the dynamically rendered form to add an additional input field to the dynamically rendered form. Additionally, or alternatively, in some implementations, to apply the one or more modifications to the rendering of the dynamically rendered form, the computing device can modify the rendering of the dynamically rendered form to add an additional input field to the dynamically rendered form. Additionally, or alternatively, in some implementations, to apply the one or more modifications to the rendering of the dynamically rendered form, the computing device can modify a field type of at least one of the one or more input fields of the dynamically rendered form.

In some implementations, the computing device can receive, from the server computing system, a second data object generated based on the user input information. The second data object can be indicative of a second dynamically rendered form that includes one or more second input fields. The second data object can include information indicative of a field type for each of the one or more second input fields. Based on the second data object, the computing device can display a rendering of the second dynamically rendered form.

FIG. 3B depicts a flow chart diagram of an example method 300B to perform modification or generation of a data object for local dynamic rendering of a dynamically rendered form according to example implementations of the present disclosure. Although FIG. 3B depicts operations performed in a particular order for purposes of illustration and discussion, the methods of the present disclosure are not limited to the particularly illustrated order or arrangement. The various operations of the method 300B can be omitted, rearranged, combined, and/or adapted in various ways without deviating from the scope of the present disclosure.

At operation 302B, a computing system can obtain contextual user information. The contextual user information can include information descriptive of one or more users. Additionally, or alternatively, the contextual user information can include information provided by the one or more users to an existing input field. In some implementations, the data object can further include information indicative of a layout of the one or more input fields within the dynamically rendered form. Additionally, or alternatively, in some implementations, the data object can further include interface information that defines a particular data object format that is compatible with a dynamic form interface of the computing system. The computing system can receive, from the user computing device, a response data object of the particular data object format. The response data object can be descriptive of the user input information.

At operation 304B, the computing system can, based on the contextual user information, select a data object of a plurality of data objects. The data object is indicative of one or more input fields of a dynamically rendered form. The data object includes information indicative of a field type for each of the one or more input fields.

At operation 306B, the computing system can send rendering information to a user computing device associated with a user of the one or more users. The rendering information can include the data object and instructions to render the dynamically rendered form from the data object. In some implementations, the computing system can provide instructions to apply one or more modifications to the dynamically rendered form. The instructions are based at least in part on the user input information.

In some implementations, providing the instructions to apply the one or more modifications to the dynamically rendered form can include providing instructions to add an additional input field to the dynamically rendered form. Additionally, or alternatively, in some implementations, providing the instructions to apply the one or more modifications to the dynamically rendered form can include providing instructions to modify a field type of at least one of the one or more input fields of the dynamically rendered form.

In some implementations, the computing system can, based on the user input information, modify a second data object to add one or more second input fields to the second data object. The computing system can send second rendering information to the user computing device associated with the user of the one or more users. The second rendering information can include the second data object and instructions to render a second dynamically rendered form from the second data object.

In some implementations, based on the user input information, the computing system can select one or more second input fields for inclusion in a second data object. the computing system can generate the second data object. The second object can indicate the one or more second input fields. The computing system can send second rendering information to the user computing device associated with the user of the one or more users. The second rendering information can include the second data object and instructions to render a second dynamically rendered form from the second data object.

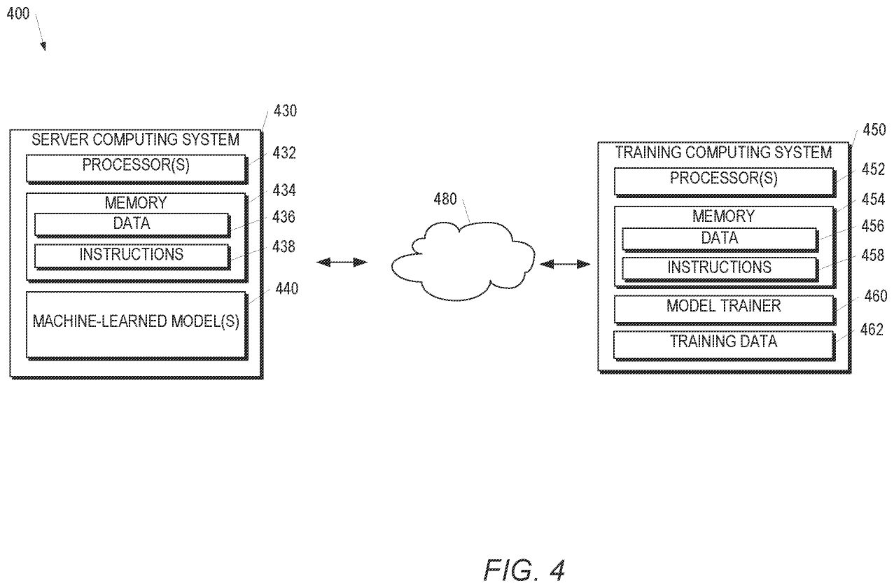

FIG. 4 depicts a block diagram of an example computing system 400 that provides data objects for rendering of dynamically rendered forms according to example implementations of the present disclosure. The system 400 includes a server computing system 430 and a training computing system 450 that are communicatively coupled over a network 480.

The server computing system 430 includes one or more processors 432 and a memory 434. The one or more processors 432 can be any suitable processing device (e.g., a processor core, a microprocessor, an ASIC, an FPGA, a controller, a microcontroller, etc.) and can be one processor or a plurality of processors that are operatively connected. The memory 434 can include one or more non-transitory computer-readable storage media, such as RAM, ROM, EEPROM, EPROM, flash memory devices, magnetic disks, etc., and combinations thereof. The memory 434 can store data 436 and instructions 438 which are executed by the processor 432 to cause the server computing system 430 to perform operations.

In some implementations, the server computing system 430 includes or is otherwise implemented by one or more server computing devices, virtualized computing devices, compute nodes, compute instances, etc. If the server computing system includes a plurality of computing devices, the multiple computing devices can operate according to sequential computing architectures, parallel computing architectures, or some combination thereof.

The server computing system 430 can store or otherwise include one or more machine-learned models 440. For example, the models 440 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). In particular, the machine-learned models 440 can include foundational models with many parameters trained using large quantities of information. Examples of such models include large language models.

The server computing system 430 can train the model(s) 440 via interaction with a training computing system 450 that is communicatively coupled over the network 480. The training computing system 450 can be separate from the server computing system 430 or can be a portion of the server computing system 430.

The training computing system 450 includes one or more processors 452 and a memory 454. The one or more processors 452 can be any suitable processing device (e.g., a processor core, a microprocessor, an ASIC, an FPGA, a controller, a microcontroller, etc.) and can be one processor or a plurality of processors that are operatively connected. The memory 454 can include one or more non-transitory computer-readable storage media. For example, the memory 454 can include RAM, ROM, flash memory devices, etc. The memory 454 can store data 456 and instructions 458 which are executed by the processor 452 to cause the training computing system 450 to perform operations. In some implementations, the training computing system 450 includes or is otherwise implemented by one or more server computing devices.

The training computing system 450 can include a model trainer 460 that is capable of training machine-learned models. Specifically, the model trainer 460 can train the machine-learned model(s) 440 implemented by the server computing system 430 using various training or learning techniques. For example, the training computing system can implement training techniques such as backwards propagation of errors. To follow the previous example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Where possible, gradient descent techniques can be used to iteratively update the parameters over a number of training iterations.

In some implementations, performing backwards propagation of errors can include performing truncated backpropagation through time. The model trainer 460 can perform a number of generalization techniques (e.g., weight decays, dropouts, etc.) to improve the generalization capability of the models being trained. The model trainer 460 can train the models 440 based on a set of training data 462. The training data 462 can include, for example, a large quantity of training information sufficient to train a foundational model to perform multiple types of tasks.

The model trainer 460 includes computer logic utilized to provide desired functionality. The model trainer 460 can be implemented in hardware, firmware, and/or software controlling a processor. For example, in some implementations, the model trainer 460 includes programmatic instructions stored on a storage device, loaded into a memory and executed by one or more processors. In other implementations, the model trainer 460 includes one or more sets of computer-executable instructions that are stored in a tangible computer-readable storage medium such as RAM, hard disk, or optical or magnetic media.

The network 480 can be any type of communications network, such as a local area network (e.g., intranet), wide area network (e.g., Internet), or some combination thereof and can include any number of wired or wireless links. In general, communication over the network 480 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

Individuals will recognize improvements and modifications to the preferred examples of the disclosure. All such improvements and modifications are considered within the scope of the concepts disclosed herein and the claims that follow.

What is claimed is:

1. A user computing device, comprising:
one or more processor devices;
one or more non-transitory computer-readable media storing instructions that, when executed by the one or more processor devices, cause the one or more processors to perform operations, the operations comprising:
sending contextual user information to a server computing system, the contextual user information comprising:
information descriptive of a user of the user computing device; or
information received from the user via an existing input field of an existing form rendered by the user computing device;
receiving, from the server computing system, a data object generated based on the contextual user information, wherein the data object is indicative of one or more input fields of a dynamically rendered form, and wherein the data object comprises information indicative of a field type for each of the one or more input fields; and
based on the data object, displaying a rendering of the dynamically rendered form comprising the one or more input fields.

2. The user computing device of claim 1, wherein the data object further comprises information indicative of a layout of the one or more input fields within the dynamically rendered form.

3. The user computing device of claim 1, wherein sending the contextual user information to the server computing system comprises sending, to the computing system, the information received from the user via the existing input field of the existing form rendered by the user computing device; and
wherein displaying the rendering of the dynamically rendered form comprising the one or more input fields comprises:
receiving an input from the user, wherein the input selects a navigation interface element that navigates from the existing form rendered by the user computing device to a subsequent form;
obtaining the rendering of the dynamically rendered form; and
based on the data object, displaying the rendering of the dynamically rendered form.

4. The user computing device of claim 3, wherein obtaining the rendering of the dynamically rendered form comprises:
based on the data object, generating the rendering of the dynamically rendered form.

5. The user computing device of claim 3, wherein obtaining the rendering of the dynamically rendered form comprises:
receiving the rendering of the dynamically rendered form from a computing entity other than the user computing device.

6. The user computing device of claim 1, wherein the operations further comprise:
receiving user input information input by the user to the one or more input fields.

7. The user computing device of claim 6, wherein the data object further comprises interface information that defines a particular data object format that is compatible with a dynamic form interface of the server computing system; and
wherein the operations further comprise:
based on the interface information, generating a response data object of the particular data object format, wherein the response data object is descriptive of the user input information; and
sending the response data object to the server computing system via the dynamic form interface of the server computing system.

8. The user computing device of claim 7, wherein the operations further comprise:
receiving, from the server computing system, instructions to apply one or more modifications to the dynamically rendered form, wherein the instructions are based at least in part on the user input information; and
applying the one or more modifications to the rendering of the dynamically rendered form.

9. The user computing device of claim 8, wherein applying the one or more modifications to the rendering of the dynamically rendered form comprises:
modifying the rendering of the dynamically rendered form to add an additional input field to the dynamically rendered form.

10. The user computing device of claim 8, wherein applying the one or more modifications to the rendering of the dynamically rendered form comprises:
modifying a field type of at least one of the one or more input fields of the dynamically rendered form.

11. The user computing device of claim 7, wherein the operations further comprise:
receiving, from the server computing system, a second data object generated based on the user input information, wherein the second data object is indicative of a second dynamically rendered form comprising one or more second input fields, and wherein the second data object comprises information indicative of a field type for each of the one or more second input fields; and
based on the second data object, displaying a rendering of the second dynamically rendered form.

12. A computer-implemented method for dynamic form generation based on contextual information, the method comprising:
obtaining, by a computing system comprising one or more computing devices, contextual user information comprising one or more of:
information descriptive of one or more users; or
information provided by the one or more users to an existing input field;
based on the contextual user information, selecting, by the computing system, a data object of a plurality of data objects, wherein the data object is indicative of one or more input fields of a dynamically rendered form, and wherein the data object comprises information indicative of a field type for each of the one or more input fields; and
sending, by the computing system, rendering information to a user computing device associated with a user of the one or more users, wherein the rendering information comprises the data object and instructions to render the dynamically rendered form from the data object.

13. The computer-implemented method of claim 12, wherein the data object further comprises information indicative of a layout of the one or more input fields within the dynamically rendered form.

14. The computer-implemented method of claim 12, wherein the data object further comprises interface information that defines a particular data object format that is compatible with a dynamic form interface of the computing system; and
wherein the method further comprises receiving, by the computing system from the user computing device, a response data object of the particular data object format, wherein the response data object is descriptive of user input information input by the user to the one or more input fields.

15. The computer-implemented method of claim 14, wherein the method further comprises:
providing, by the computing system, instructions to apply one or more modifications to the dynamically rendered form, wherein the instructions are based at least in part on the user input information.

16. The computer-implemented method of claim 15, wherein providing the instructions to apply the one or more modifications to the dynamically rendered form comprises:
providing, by the computing system, instructions to add an additional input field to the dynamically rendered form.

17. The computer-implemented method of claim 15, wherein providing the instructions to apply the one or more modifications to the dynamically rendered form comprises:
providing, by the computing system, instructions to modifying a field type of at least one of the one or more input fields of the dynamically rendered form.

18. The computer-implemented method of claim 14, wherein the method further comprises:
based on the user input information, modifying, by the computing system, a second data object to add one or more second input fields to the second data object; and
sending, by the computing system, second rendering information to the user computing device associated with the user of the one or more users, wherein the second rendering information comprises the second data object and instructions to render a second dynamically rendered form from the second data object.

19. The computer-implemented method of claim 14, wherein the method further comprises:
based on the user input information, selecting, by the computing system, one or more second input fields for inclusion in a second data object;
generating, by the computing system, the second data object, wherein the second data object is indicative of the one or more second input fields; and
sending, by the computing system, second rendering information to the user computing device associated with the user of the one or more users, wherein the second rendering information comprises the second data object and instructions to render a second dynamically rendered form from the second data object.

20. One or more non-transitory computer-readable media storing instructions that, when executed by one or more processor devices, cause the one or more processor devices to perform operations, the operations comprising:
obtaining contextual user information comprising one or more of:
information descriptive of one or more users; or
information provided by the one or more users to an existing input field;
based on the contextual user information, selecting one or more input fields for inclusion in a data object;
generating the data object, wherein the data object is configured to cause a recipient device to render a dynamically rendered form from the data object, and wherein the data object comprises information indicative of a field type for each of the one or more input fields; and
sending rendering information to a user computing device associated with a user of the one or more users, wherein the rendering information comprises the data object and instructions to render the dynamically rendered form from the data object.
